(19) United States
(12) Patent Application Publication
(10) Pub. No.: US 2008/0279040 A1
(43) Pub. Date: Nov. 13, 2008

(54) FROZEN DRINK MIXER HAVING A LID WHICH ENGAGES A CUP FOR DRINK MIXING AND CLEANING OF MIXING COMPONENTS

(76) Inventor: Jim L. Neilson, Pleasant Grove, UT (US)

Correspondence Address: Angus C. Fox, III, 4093 N. Imperial Way, Provo, UT, 84604-5386, US

(21) Appl. No.: 11/747,233

(22) Filed: May 11, 2007

(51) Int. Cl. B01F 7/16

(52) U.S. Cl. 366/176.1; 366/206

(57) ABSTRACT

A drink mixer includes a frame; a support having a drain; a lid having an annular groove and movable relative to a mounted mixing cup from an elevated position to a mating position where the annular groove engages the cup's rim; a mixer shaft passing through the lid; a motor coupled to the mixer shaft; a blade assembly coupled to a lower end of the mixer shaft, the blade assembly alternately assuming either a retracted position within the lid or an extended position within a mounted cup; a mechanism for alternatively bringing said support and said lid towards one another so that the annular groove of said lid can engage the rim of a mounted cup, or moving the cup and lid apart; a mechanism for alternately establishing the retracted and extended positions; and a mechanism for dispensing washing solution into the cleaning cup.

### BACKGROUND OF THE INVENTION

1. Field of the Invention

The invention relates generally to apparatus for mixing ingredients in a receptacle and, more particularly, to mixers used for blending frozen, liquid and solid ingredients, such as ice, ice cream, frozen yogurt, frozen custard, malted milk and fruit into milk shakes, malted-milk shakes, yogurt shakes, custard shakes and the like.

2. History of the Prior Art

Single drink mixing machines are very common in the restaurant and food service industries. The focus of many present-day businesses is the mixing of specialty drinks for customers while they wait. Although there are many varieties of specialty drinks, most require the blending of one or more frozen, liquid or solid ingredients chosen from the following list: ice, ice cream, frozen yogurt, frozen custard, milk, malted milk, fruit, flavored syrup, confections, chocolate, nuts, and herbs. Flavored ice drinks, milk shakes, malted-milk shakes, yogurt shakes, custard shakes, and fruit “smoothie” drinks, are just some of the more popular results of the mixing process.

The development of the blender revolutionized the making of mixed drinks. In 1922, Stephen Poplawski developed the first blender having a spinning blade at the bottom of a mixing container. Poplawski's appliance was used primarily to make soda fountain drinks. With financial backing from big band leader Fred Waring, Fred Osius worked to improve the Poplawski device and, in 1933, filed a patent on an improved blender. When the Osius machine failed to meet Waring's reliability and performance expectations, Waring-a one-time Penn State architectural and engineering school student-fired Osius and supervised a complete redesign of the blender himself. Finally, in 1937, the Waring-owned Miracle Mixer Corporation introduced the Miracle Mixer blender at the National Restaurant Show in Chicago for the then princely retail price of $29.75 (approximately $1,500 in 2007 dollars). In 1938, Fred Waring renamed his Miracle Mixer Corporation the Waring Corporation, and changed the mixer's name to the Waring Blender. Mr. Waring was a one-man marketing phenomenon, and by the end of 1954, he had sold over one million units to restaurants and upscale stores throughout the country.

Also known in the prior art are conventional milk shake machines consisting of an electric motor, shaft, and mixing disc. The device is supported on a stand or hangs from a wall bracket. When one wishes to make a hard ice cream milk shake, a metal cup is manually held under the revolving shaft and disc while the cup is manually manipulated vertically and in a stirring motion. This method is time consuming and inefficient and may even introduce foreign matter into the mixture as a result of the mixing head coming into contact with the sides of the metal cup.

U.S. Pat. No. 5,150,967, which issued to J. L. Neilson, et al. on Sep. 29, 1992, discloses a milk shake machine for mixing thick, hard ice cream shakes. The machine incorporates a housing to which a container is locked and sealed, the container being in a suspended, elevated condition. Two gear motors are disposed within the housing, one employed to rotate a shaft and mixing head and the other to move the mixing head vertically within the container. While the milk shake machine disclosed in U.S. Pat. No. 5,150,967 has a number of advantages over the conventional prior art milk shake machines, it too has certain deficiencies, not the least of which is the fact that the cup or receptacle is not positively supported on its bottom, but rather is suspended from its upper end in mid air. This approach can result in spillage if the user does not properly connect the receptacle to the housing. Some difficulties may also arise with respect to cleaning of the housing structure at the point of attachment of the container or receptacle to the housing.

U.S. Pat. No. 5,328,263, which issued to J. L. Neilson on Jul. 12, 1994, discloses an improved drink-mixing apparatus having a lid which can be lowered to engage the rim of a mixing receptacle and raised to remove the receptacle. In addition, a mixer shaft extends downwardly through an aperture in the lid, with the shaft being movable relative to both the lid and the receptacle to permit a mixing blade assembly, which is connected to a lower end of the mixing shaft to move downwardly and upwardly within the receptacle after the lid has engaged the receptacle.

U.S. Pat. No. 5,439,289, which also issued to J. L. Neilson on Aug. 8, 1995, discloses a further embodiment of the improved drink-mixing apparatus having a support which is raised, along with the receptacle so that the receptacle engages a stationary lid. The mixer shaft extends downwardly through an aperture in the lid, with the shaft being movable relative to both the lid and the receptacle to permit a mixing blade assembly, which is connected to a lower end of the mixing shaft to move downwardly and upwardly within the receptacle after it has been raised on the support to engage the lid.

Although it is evident that the automation of drink mixing has improved considerably since the middle of the twentieth century, the mixing of drinks is still a food preparation bottleneck for restaurants and other establishments. In order to prevent contamination of a new drink with ingredients from one mixed previously and to prevent the growth of harmful or even deadly bacteria, the mixer blades and mixing container must be cleaned after each mixing operation. The elimination of dangerous bacteria is absolutely essential, both from an equipment approval standpoint and to protect the reputation of restaurants engaged in such business. When sickness or death of customers is traced to unsanitary conditions in a food-preparation establishment, it can take years to restore the reputation of the business and to quell the lawsuits and harmful publicity that are certain to follow the sickness or death of a customer traceable to the business.

Several attempts have been made throughout the years at dealing with the cleaning issue. One such attempt is exemplified by U.S. Pat. No. 1,592,788, which issued to Pablo Supervielle on Jul. 13, 1926. This patent discloses a segmented, vertically-collapsible cover having a hinged bottom cap, which encloses the agitator so that it can be washed with water sprayed from above the agitator and be protected from flying insects when not in use. A problem associated with this design is that the cover collapses and is stored in an annular chamber above the agitator. If the inner and outer surfaces of the chamber are not completely clean, the annular chamber can become an incubation chamber for bacteria.

U.S. Pat. No. 7,144,150 to James J. Farrell, discloses a drink mixer having a rinseable splash shield. A euphemism for a lid, the splash shield, which weighs about 8 pounds, according to the inventor, is downwardly biased by gravity. The splash shield and blade can be rinsed with a water jet provided within the mixer housing. There are at least two problems with this device. First, the gravity-biased splash shield, or lid, prevents rapid mixing of drinks made of frozen ice cream, as the agglomerated mass of ice cream will adhere to the mixing blade and lift even an eight-pound lid. Thus, the inventor states that 40 seconds may be required to fully mix such a drink. The second problem with the Farrell device is that the rinsing action is not likely to completely clean the mixing shaft where it passes through the splash shield or the many crevices, hinges and overlapping regions that result from this overly complex design. Farrell had access to an early mixer designed by the present inventor in the early 1990s for many months, has attempted to purchase the Neilson patents, and has been attempting to design around the patented Neilson mixer devices for many years. What is needed is a method and apparatus that are both convenient and fast for cleaning the elements of a drink mixing apparatus that are exposed to the mixed drinks so that opportunities for bacterial growth are minimized and the equipment cleaning bottleneck is eliminated.

### SUMMARY OF THE INVENTION

The present invention addresses the need for frequent cleaning of drink-mixing machines and provides method and apparatus that are both quick and convenient.

In accordance with the present invention, an apparatus is provided for mixing consumable ingredients such as ice, ice cream, frozen yogurt, frozen custard, malted milk and fruit into milk shakes, malted-milk shakes, yogurt shakes, custard shakes and the like in a mixing cup having a circular rim. The apparatus includes a frame; a cleaning cup that can be substituted for the mixing cup, the cleaning cup being of similar size and shape, but having a bottom with an aperture; a support coupled to the frame for precise, axial, non-rotational mounting and support of the mixing or cleaning cup, the support having a drain that couples to the bottom aperture of the cleaning cup when the latter is mounted on the support; a lid both positioned above the support and coupled to the frame, the lid having an annular groove on a lower surface thereof which is equipped with a silicone rubber seal; a rotatably-mounted mixer shaft coupled to the frame, the mixer shaft being coaxial with both a mounted mixing cup and the annular groove, and passing through the lid; a mixing motor coupled to the mixer shaft; a blade assembly coupled to a lower end of the mixer shaft, the blade assembly assuming either a retracted position where it is recessed within the lid or an extended position where the blade assembly is nearer the support, but still within the confines of a mounted cup; a positioning system for alternatively bringing the support and the lid towards one another so that the annular groove of the lid can engage the rim of a mounted cup, and also distancing the support and lid from one another so that the rim of a mounted cup can disengage from the annular groove of the lid; a locating system for alternatively bringing the support and the lid towards one another so that the annular groove of the lid can engage the rim of a mounted cup, and distancing the support and the lid from one another so that the rim of a mounted cup can disengage from the annular groove of the lid; and a cleaning system for dispensing washing solution into the cleaning cup. For a presently preferred embodiment of the invention, the mixer shaft is rotatably mounted within a non-rotating sleeve, which passes through the lid. Two primary embodiments of the invention are disclosed.

For the first main embodiment of the invention, a mixing cup or cleaning cup is mounted on a stationary support, the lid and retracted blade assembly are lowered in order to engage the circular rim of a mounted mixing or cleaning cup; maintaining that engagement, the lid and mounted cup remain stationary while the blade assembly continues its downward movement, thereby leaving its retracted position within the lid and moving to an extended position near the bottom of the cup. In order to provide the described functionality for the first embodiment, a vertical track is rigidly secured to the frame. An upper trolley that is bidirectionally and vertically movable is mounted on the vertical track. A reversible positioning system raises and lowers the upper trolley. A relatively simple and reliable positioning system can be provided using a jack screw that is rotatably mounted to the frame. The jack screw, which is coupled to a reversible electric motor, acts on the upper trolley. The upper trolley is coupled to the mixer shaft, so that the latter moves at the same vertical speed and with the same range of movement as the upper trolley. The lid is rigidly affixed to a lower trolley that is mounted on the track below the upper trolley and is also bidirectionally and vertically movable. Upward movement of the lower trolley is provided by mechanical coupling to the upper trolley, the latter having a range of vertical movement greater than the former; downward movement of the lower trolley is provided by a combination of gravity and spring tension. In one embodiment of the invention that has been reduced to practice, the mixer shaft is slidably coupled to a splined power shaft that is rotatably coupled to the frame and coupled to the mixing motor through a transmission shiftable between low-speed, high-torque and high-speed, low-torque settings. A transmission has been reduced to practice by having first and second parallel shafts, the first shaft being the splined power shaft, and the second shaft being another splined shaft that is directly coupled to the mixing motor. Each of the parallel shafts has both large-diameter and small-diameter wheels, with the large-diameter wheel on one shaft being coupled to the small-diameter wheel on the other with a drive loop. A sliding shift collar on each shaft is employed to alternately rotationally lock either coupled pair to both parallel shafts such that only a single coupled wheel pair and drive loop is functional at any given time.

For the second main embodiment, the blade assembly remains at a constant elevation with respect to the frame, the support and a mounted cup are raised in order to engage the annular groove of the lid and, then, the support and the mounted cup are raised an additional distance, lifting the lid in the process, so that the blade assembly can be positioned near the bottom of the mounted cup. In order to provide the described functionality for the second embodiment, a vertical track is rigidly secured to the frame. A trolley that is bidirectionally and vertically movable is mounted on the vertical track. A reversible positioning system raises and lowers the trolley, which is directly coupled to the cup support. A relatively simple and reliable positioning system can be provided using a jack screw that is rotatably mounted to the frame. The jack screw, which is coupled to a reversible electric motor, acts on the trolley. The lid, which is slidably mounted on a non-rotating sleeve of the mixer shaft and rigidly attached to a trolley, which is slidably mounted on a vertical track that is rigidly affixed to the frame, is gravity and spring biased in a downward vertical direction. As the positioning system raises the trolley, the support, and a cup mounted on the support, the cup makes contact with the lid and overcomes the gravity and spring biasing, thereby causing the lid to rise and to expose the mixer shaft and attached blade assembly. The mixer shaft is directly coupled to a power shaft, that is coupled to a mixing motor through a transmission shiftable between low-speed, high-torque and high-speed, low-torque settings. A transmission has been reduced to practice by having first and second parallel shafts, the first shaft being the splined power shaft, and the second shaft being another splined shaft that is directly coupled to the mixing motor. Each of the parallel shafts has both large-diameter and small-diameter wheels, with the large-diameter wheel on one shaft being coupled to the small-diameter wheel on the other with a drive loop. A sliding shift collar on each shaft is employed to alternately rotationally lock either coupled pair to both parallel shafts such that only a single coupled wheel pair and drive loop is functional at any given time. When paper cups are used with the second main embodiment frozen drink mixer, a support cup must be used to prevent the downward biasing of the lid from collapsing the paper cup. The sleeve can be formed from multiple component sleeves which can be used in various combinations with different sizes of paper cups.

For either main embodiment of the invention, washing solution is dispensed into the cleaning cup by the cleaning system, which may utilize one of two currently planned embodiments. For a first embodiment of the cleaning system, a chamber is provided which surrounds a portion of the mixer shaft and which is superjacent the lid. Washing solution, which includes water from a pressurized source along with an adjustable amount of detergent and/or sanitizing solution, is admitted to the chamber by a solenoid-controlled valve on demand. The cleaning system is designed so that the solenoid is disabled if the cleaning cup is not positioned on the support. The chamber has at least one path at a lower end thereof that exits at the bottom of the lid within the confines of the annular groove, so that washing solution dispensed by the solenoid will flow into the cleaning cup. For a second embodiment of the distribution system, no chamber is provided. The washing solution is still supplied by a solenoid-controlled valve, but instead first entering a chamber above the lid, it sprays directly into the cleaning cup through at least one aperture or spray nozzle in a lower surface of the lid that is within the confines of the annular groove. The lid also incorporates a one-way valve which allows air to enter a mixing cup that is sealed with the lid. The one-way valve is closed when washing solution is dispensed into the cleaning cup. A wiping seal, which is centered in the lid seals a gap between the lid and the mixer shaft, prevents mixed ingredients and washing solution from escaping in an upward direction and thereby eliminating the growth of bacteria cultures within the apparatus that could contaminate the mixed ingredients.

### BRIEF DESCRIPTION OF THE DRAWINGS (PHOTOGRAPHS)

FIG. 1 is a front elevational view of a first main embodiment frozen drink mixer with the lid in an elevated position;

FIG. 2 is a front elevational view of the first main embodiment frozen drink mixer with the lid in a lowered position and the blade assembly in a retracted position;

FIG. 3 is a front elevational view of the first main embodiment frozen drink mixer with the lid in a lowered position and the blade assembly in an extended position;

FIG. 4 is a right-side elevational view of the first main embodiment frozen drink mixer with the lid in an elevated position;

FIG. 5 is a left-side elevational view of the first main embodiment frozen drink mixer with the lid in an elevated position;

FIG. 6 is a top plan view of a first embodiment lid;

FIG. 7 is a front elevational view of the first embodiment lid;

FIG. 8 is a bottom plan view of the first embodiment lid;

FIG. 9 is a cross-sectional view of the first embodiment lid, taken through its central axis;

FIG. 10 is a side elevational view of a bushing that presses into the first embodiment lid;

FIG. 11 is a top plan view of a first embodiment cleaning unit housing;

FIG. 12 is a front elevational view of the first embodiment cleaning unit housing;

FIG. 13 is a bottom plan view of the first embodiment cleaning unit housing;

FIG. 14 is a cross-sectional view of the first embodiment cleaning unit housing, taking through its central axis;

FIG. 15 is a top plan view of a spray insert, which fits into the first embodiment cleaning unit housing;

FIG. 16 is a side elevational view of the spray insert of FIG. 15;

FIG. 17 is a bottom plan view of the spray insert of FIG. 15;

FIG. 18 is a side elevational view of a bushing that presses into the top of the spray insert of FIG. 15;

FIG. 19 is a cross-sectional view of the spray insert of FIGS. 15, 16 and 17, taken through its central axis;

FIG. 20 is a top plan view of a small-diameter rubber O-ring seal;

FIG. 21 is a side elevational view of the small-diameter rubber O-ring seal of FIG. 20;

FIG. 22 is a top plan view of a large-diameter rubber O-ring seal;

FIG. 23 is a side elevational view of the large-diameter rubber O-ring seal of FIG. 22;

FIG. 24 is an exploded view of the first embodiment lid, the spray insert, the first embodiment cleaning unit housing, and associated bushings and rubber O-ring seals;

FIG. 25 is a front elevational view of the assembled components of FIG. 24, clamped in a first embodiment lower trolley bracket;

FIG. 26 is a cross-sectional view of the assembly of FIG. 25;

FIG. 27 is a top plan view of a second embodiment cleaning unit housing;

FIG. 28 is a front elevational view of the second embodiment cleaning unit housing;

FIG. 29 is a bottom plan view of the second embodiment cleaning unit housing;

FIG. 30 is a cross-sectional view of the second embodiment cleaning unit housing, taken through its central axis;

FIG. 31 is a top plan view of a second embodiment lid;

FIG. 32 is a front elevational view of the second embodiment lid;

FIG. 33 is a bottom plan view of the second embodiment lid;

FIG. 34 is a cross-sectional view of the second embodiment lid, taken through its central axis;

FIG. 35 is an exploded view of the second embodiment lid, a wiper seal, the second embodiment cleaning unit housing, and associated rubber O-ring seals;

FIG. 36 is a front elevational view of the assembled components of FIG. 35, clamped in a second embodiment lower trolley bracket;

FIG. 37 is a cross-sectional view of the assembly of FIG. 36, taken through its central axis;

FIG. 38 is a top plan view of a cup support having a central drain;

FIG. 39 is an enlarged side elevational view of the cup support of FIG. 38;

FIG. 40 is a right-side elevational view of the first main embodiment of FIGS. 1 through 5, but adapted to use a second embodiment lid and cleaning unit;

FIG. 41 is right-side elevational view of a second main embodiment frozen drink mixer having a cup installed on a cup support having a central drain, the cup support being mounted on a movable platform that is in a lowermost position;

FIG. 42 is a right-side elevational view of the second main embodiment frozen drink mixer of FIG. 41, but with the platform and mounted cup in an uppermost position, which has caused the lid and second embodiment cleaning unit to lift and expose the mixing shaft and attached blade assembly;

FIG. 43 is a cross-sectional view of a cleaning cup having a central drain in the base thereof;

FIG. 44 is an exploded view of a three-piece outer cup sleeve;

FIG. 45 is an elevational view of an assembled three-piece cup sleeve;

FIG. 46 is a cross-sectional, or profile, view of the assembled, three-piece cup sleeve of FIG. 45;

FIG. 47 is a top plan view of a cup support, movable platform, drain chute, back wall, trolley, and lower trolley attachment bracket of the second main embodiment frozen drink mixer shown in FIGS. 41 and 42;

FIG. 48 is an elevational view of a first embodiment mixing shaft assembly and support bracket;

FIG. 49 is a cross-sectional view of the first embodiment mixing shaft assembly and support bracket; and

FIG. 50 is a cross-sectional view of a second embodiment mixing shaft assembly.

### DETAILED DISCLOSURE OF THE INVENTION

The present invention will now be described with reference to the attached drawings. It should be understood that the drawings are not necessarily drawn to scale and are meant to be merely illustrative of the various aspects of the invention. Two main embodiments of the invention are disclosed which concern closure of a mounted cup with the lid before mixing or cleaning functions can proceed. Two embodiments of a cleaning system are also disclosed. Either of the cleaning systems may be utilized with either of the main embodiments of the invention. Thus, there are essentially four combinations of embodiments.

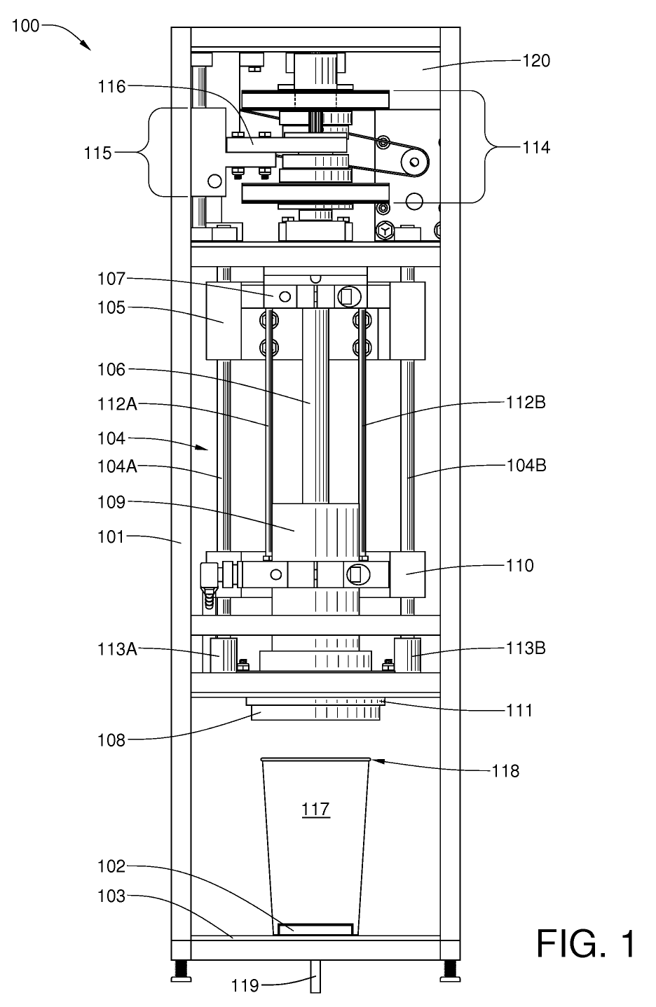

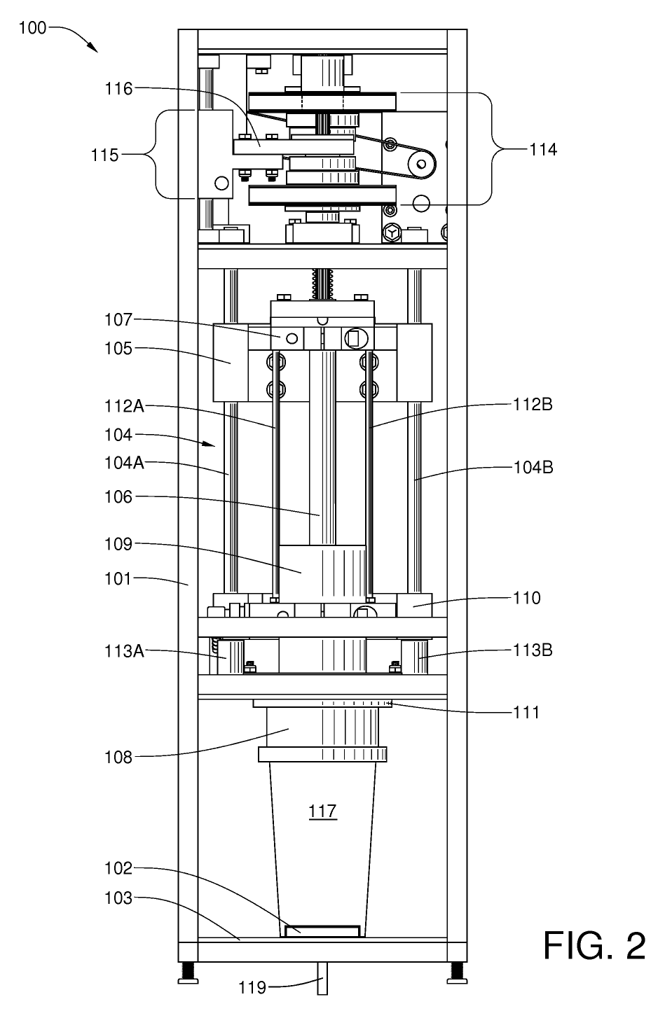

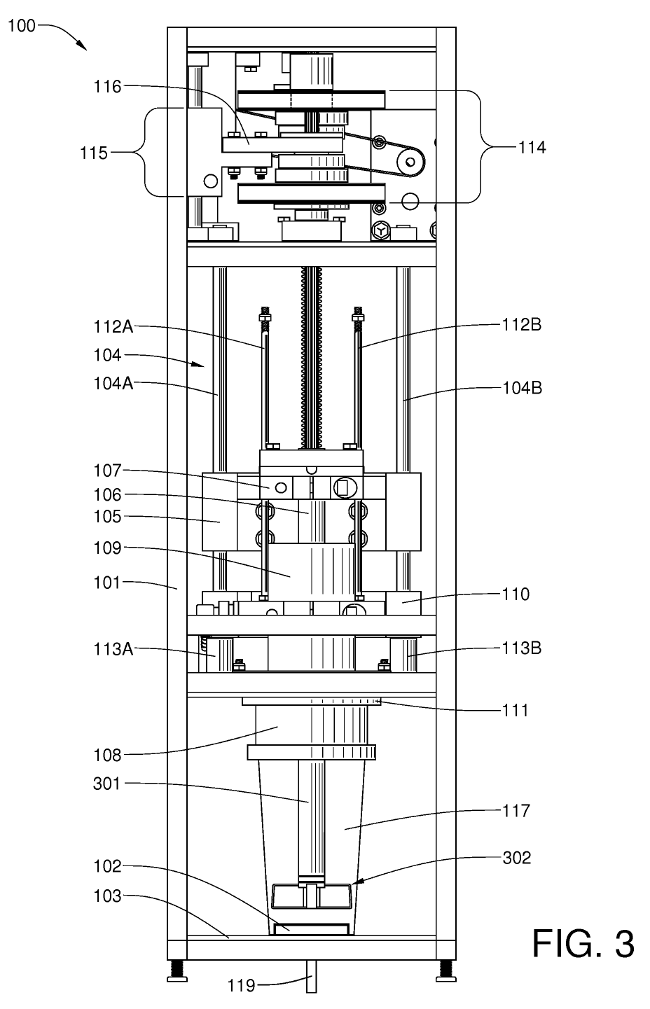

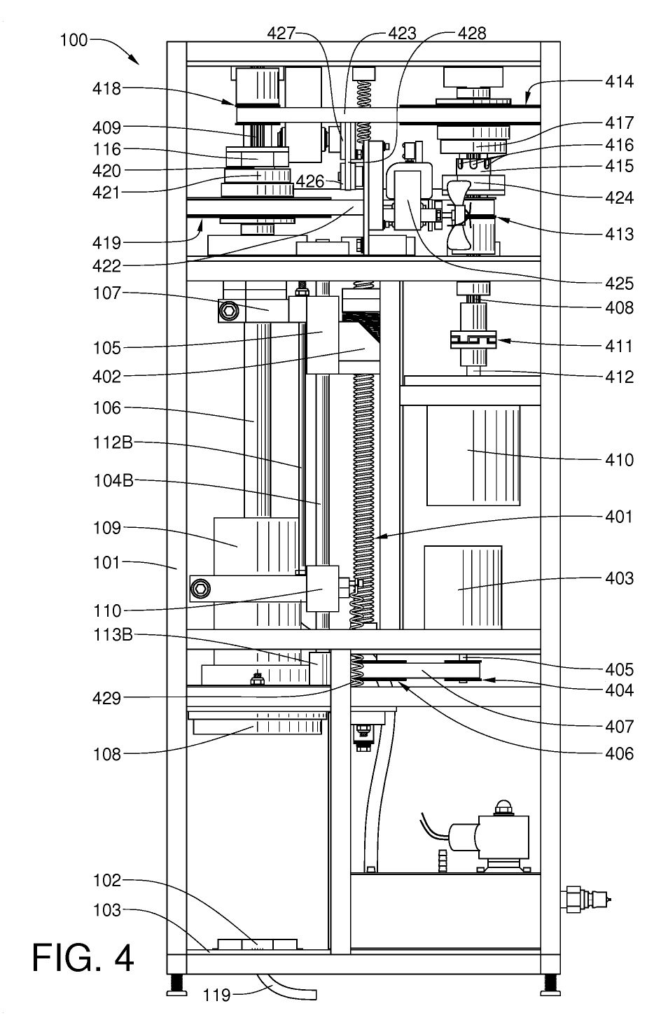

Referring now to the front view of FIG. 1, a first main frozen drink mixer 100 includes a frame 101, a cup support 102 mounted on a platform 103 suspended within the frame 101, a vertical track 104 comprising a pair of parallel cylindrical trolley guide rods 104A and 104B which are rigidly secured to the frame 101, an upper trolley 105 that is slidably mounted on the vertical track 104, a jack screw coupled to a reversible electric drive motor (neither of which are visible in this view) which, together, raise and lower the upper trolley 105. A non-rotating sleeve 106 is rigidly clamped within an upper attachment bracket 107 that is rigidly affixed to the upper trolley 105 so that the sleeve 106 moves with the upper trolley 105 as the latter is raised and lowered. A lid 108 is rigidly attached to a first embodiment cleaning unit housing 109. The cleaning unit housing 109 is rigidly clamped within a lower trolley 110 that also is slidably mounted on the vertical track 104 and bidirectionally and vertically movable. The lid 108 slides up and down within a collar 111 that is rigidly attached to the frame 101. Upward movement of the lower trolley 110 is provided by mechanical coupling to the upper trolley 105 via a pair of parallel coupling rods 112A and 112B. The upper trolley 105 has a range of vertical movement that is greater than the range of movement of the lower trolley 110. Downward movement of the lower trolley 110 is provided by a combination of gravity and spring tension, and is limited by a pair of cylindrical stops 113A and 113B which are secured to lowermost portions of cylindrical rods 104A and 104B, respectively. As will be subsequently seen, a generally hollow, internally-splined mixer shaft is rotatably mounted within the non-rotating sleeve 106, and also slidably coupled to an externally splined vertical power shaft that is rotatably coupled to the frame 101 and rotationally coupled a mixing motor through a transmission shiftable between low-speed, high-torque and high-speed, low-torque settings. The transmission 114 and shift mechanism 115 are located in an upper portion 120 of the frame 101. Although operation of the transmission 114 and the shift mechanism 115 will be described in detail with reference to drawing FIGS. 4 and 5, note should be made of the second, or front, shift collar attachment bracket 116, which is not fully visible in FIGS. 4 and 5. It will be noted that a mixing cup 117 having a circular upper rim 118 has been positioned on the stationary support 102. In order to better show the workings of the mixer 100, the cup 117 is shown as being transparent. However plastic or wax impregnated paper mixing cups may also be used. When necessary to pulverize ice in a paper cup, an internal, bottomless sheet metal or plastic mixing sleeve may be placed in the cup to prevent damage to the cup. After the mixing operation is complete, the sleeve may be removed, leaving the mixed drink within the cup. For this particular embodiment of the invention, and as will be subsequently explained in more detail, the cup support 102 has a central drain (visible in FIG. 38) that is directly connected to a bottom drain tube 119 which can be connected to waste water plumbing (not shown). A cleaning cup also having a central drain that mates with the central drain of the cup support 102 can be mounted on the cup support 102 so that sanitizing solution is automatically carried away from the mixer 100.

Referring now to FIG. 2, the upper trolley 105 has been lowered by rotation of the jack screw (not shown in this view), thereby causing the lower trolley 110, the rigidly secured cleaning unit housing 109, and the lid 108 to move downwardly until the lower trolley 110 contacts the cylindrical stops 113A and 113B. The lid 108 has an annular groove (not shown in this view) that sealably mates with the upper rim 118 of the mixing cup 117.

Referring now to FIG. 3, the upper trolley 105 has been further lowered by rotation of the jack screw (not shown in this view), thereby causing a lower portion 301 of the non-rotating sleeve 106 and the enclosed, rotatable mixing shaft (not visible in this view) to slide through the center of the cleaning unit housing 109 and lid 108. A blade assembly 302 is attached to the lower end of the rotatable mixing shaft. Following maximum downward travel of the upper trolley 105, the blade assembly 302 is positioned near the bottom of the mixing cup 117.

Referring now the right-side view of FIG. 4, the first main embodiment frozen drink mixer 100 having a first embodiment cleaning unit housing is shown with the upper trolley 105 and the lower trolley 110 returned to their original raised positions, as also shown in FIG. 1. In this view, the jack screw 401 is clearly visible, as is a jack screw follower 402, which is rigidly secured to the upper trolley 105. The reversible electric drive motor 403, which is visible in this view, is coupled to the jack screw 401 by a first toothed wheel 404 mounted on the motor output shaft 405, a second toothed wheel 406 mounted on the jack screw 401, and a toothed belt 407, which rotationally couples the first and second toothed wheels 404 and 406, respectively.

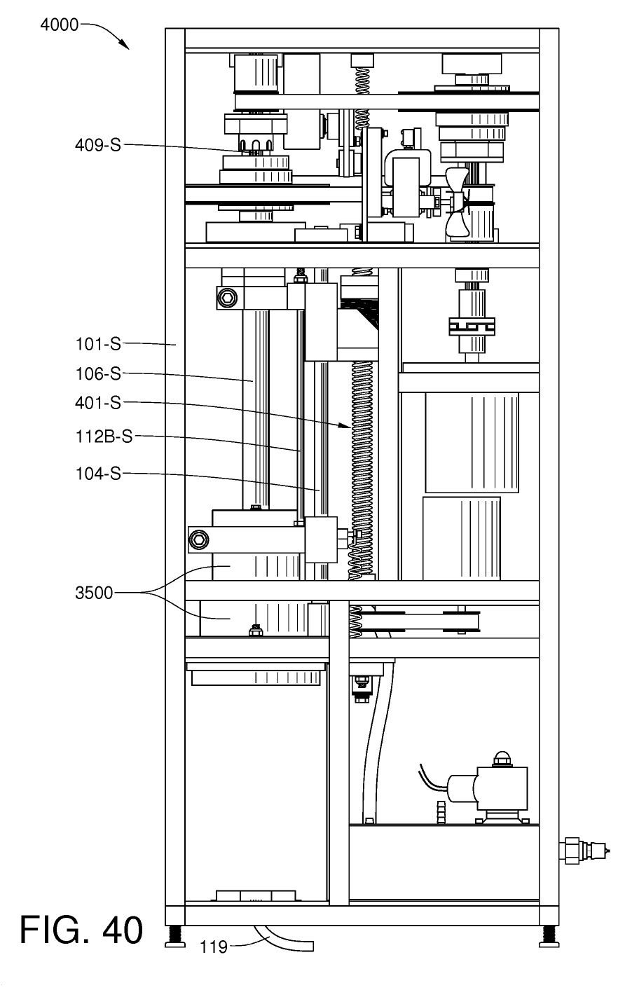

Still referring to FIG. 4, the transmission 114 has a transmission input shaft 408 and a transmission output shaft 409. Both shafts 408 and 409 are externally splined, and positioned such that their axes are vertical. The input shaft 408 is coupled to an electric mixing motor 410 through a coupler 411 which compensates for any minor misalignment between the motor output shaft 412 and the input shaft 408. The mixer shaft (still not shown) is slidably coupled to the output shaft 409. A first small-diameter toothed wheel 413 is installed on the input shaft 408, and rotates with the shaft. A first, normally free-wheeling, large diameter toothed wheel 414 is installed on the input shaft 408 above the first small-diameter toothed wheel 413. A first internally-splined shift collar 415 having equiangularly-spaced external engagement notches 416, is mounted on the input shaft 408 below the first large diameter toothed wheel 414, where it engages the external splines of the input shaft 408. The first shift collar 415 is slidable between a lower position (shown in this drawing figure), where it is disengaged from the hub 417 of the first large diameter toothed wheel 414, and an upper position (shown in drawing FIG. 40), where the external notches 416 engage a plurality of equiangularly-spaced internal engagement projections (not shown) in the hub 417 of the first large diameter toothed wheel 414, thereby rotationally coupling the latter to the input shaft 408.

Still referring to FIG. 4, a second small-diameter toothed wheel 418 is installed on the output shaft 409, and rotates with that shaft. A second, normally free-wheeling, large diameter toothed wheel 419 is installed on the output shaft 409 below the second small-diameter toothed wheel 418. A second internally-splined shift collar 420 also having equiangularly-spaced external engagement notches 416 (please refer to drawing FIG. 40), is mounted on the output shaft 409 above the second large diameter toothed wheel 419, where it engages the external splines of the output shaft 409. The second shift collar 420 is slidable between a lower position (shown in this drawing figure), where it engages a plurality of equiangularly-spaced internal engagement projections (not shown) in the hub 421 of the second large diameter toothed wheel 419, thereby rotationally coupling the latter to the output shaft 409, and an upper position (shown in the drawing FIG. 40), where it is disengaged from the hub 421 of the second large diameter toothed wheel 419.

Still referring to FIG. 4, a lower toothed belt 422 rotationally couples the first small-diameter toothed wheel 413 to the second large-diameter toothed wheel 419, while an upper toothed belt 423 rotationally couples the first large-diameter toothed wheel 414 to the second small-diameter toothed wheel 418. It should be readily apparent that the toothed wheels 413, 414, 418 and 419 and toothed belts 422 and 423 can be replaced with sprockets and chains or even with pulleys and V-belts with similar or equivalent results. Alternatively, a geared transmission may also be used.

Still referring to FIG. 4, the first and second internally-splined shift collars 415 and 420, respectively are moved up and down in unison by the shift mechanism 115, so that only one large diameter toothed wheel (414 or 419) is engaged at any one time. It will be noted that the second, or front, shift collar 420 is attached to the front shift collar attachment bracket 116 (visible in FIGS. 1 through 3), while the first, or rear, shift collar 415 is attached to a rear shift collar attachment bracket 424, which is essentially identical to the front shift collar attachment bracket 116, though inverted. There is, of course, a small range of shift collar vertical movement where neither large diameter toothed wheel is engaged to prevent multiple gear ratios from being simultaneously applied to the output shaft 409, which would result in a lock-up condition and likely destruction of the mechanical components if the input and output shafts 408 and 409, respectively, are rotating with substantial angular momentum. The shifting mechanism includes a geared, reversible electric shifter motor 425, which drives a first pulley 426. The first pulley 426 is coupled to a second pulley 427 via a drive belt 428.

Referring now to FIG. 5, the second pulley 427 is rotationally mounted to a mounting block 501 that is rigidly secured to the frame 101 so that the rotational axis of the second pulley 427 remains fixed. The second pulley 427 is reversibly rotatable through an arc of approximately 180 degrees. A pivot pin 502 is anchored to the periphery of the second pulley 427 so that it swings within a range of maximum vertical movement. The pivot pin 502 is coupled via a linkage rod 503 to a tie rod 504 that is rigidly secured to both a front shifter block 505 and a rear shifter block 506. The front shifter block 505 is slidably mounted on a front vertical shifter rod 507, while the rear shifter block 506 is slidably mounted on a rear vertical shifter rod 508. The front shifter block 505 is rigidly coupled to the front, or second, shift collar 420 via the front shift collar attachment bracket 116, while the rear shifter block 506 is rigidly coupled to the rear, or first, shift collar 415 via the rear shift collar attachment bracket 424. The securing of the front and rear shifter blocks 505 and 506, respectively, to the tie rod 504 ensures that both shift collars 415 and 420 slide up and down in unison as the pivot pin 502 swings through its range of vertical movement. A balance spring 509 counteracts the force of gravity on the shifter mechanism (which includes front and rear shifter blocks 505 and 506, the first and second shift collars 415 and 420, and the front and rear shift collar attachment brackets 116 and 424, respectively), so that the force required to raise and lower the shifter mechanism is approximately equal. Upper and lower limit switches 510U and 510L, respectively, which are mounted on a limit switch tower 511, shut off the reversible electric shifter motor 425 when high and low shifter mechanism travel limits are reached.

Still referring to FIG. 5, a solenoid-actuated valve 512 having a pressurized water inlet 513, a sanitizing solution inlet 514, and an outlet 515 for pressurized water mixed with sanitizing solution is secured to the frame 101. The outlet 515 is coupled with a tube 516 to a barbed coupling 517 that is, in turn, coupled to a fluid injector assembly 518.

Referring now to both FIGS. 4 and 5, right and left return springs 429 and 519 respectively, assist gravity in providing downward biasing to the lid 108, cleaning unit housing 109, and other components within the cleaning unit housing 109.

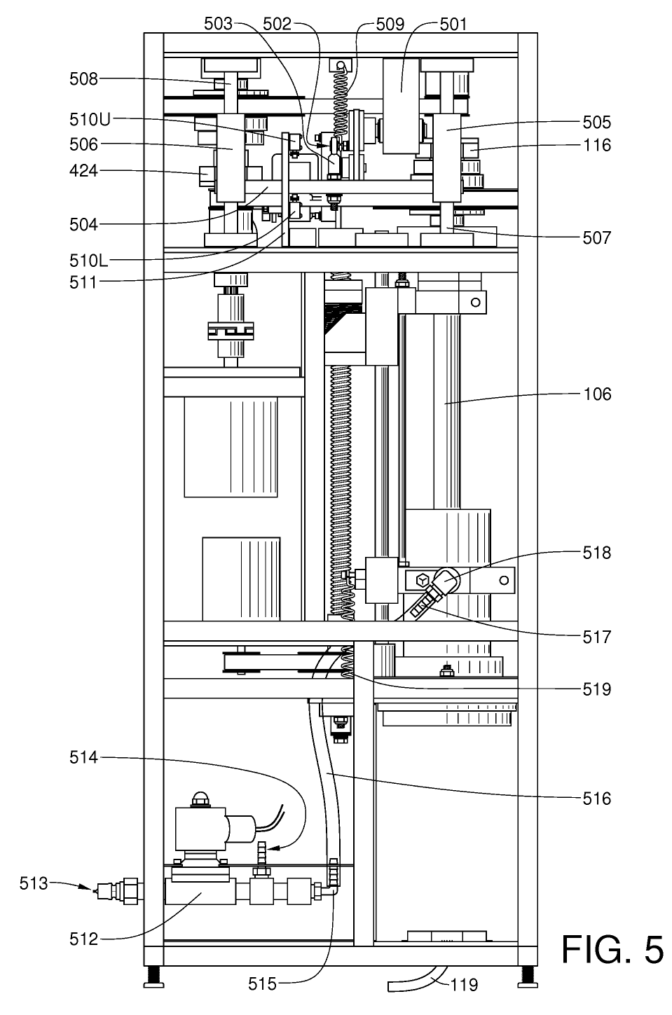

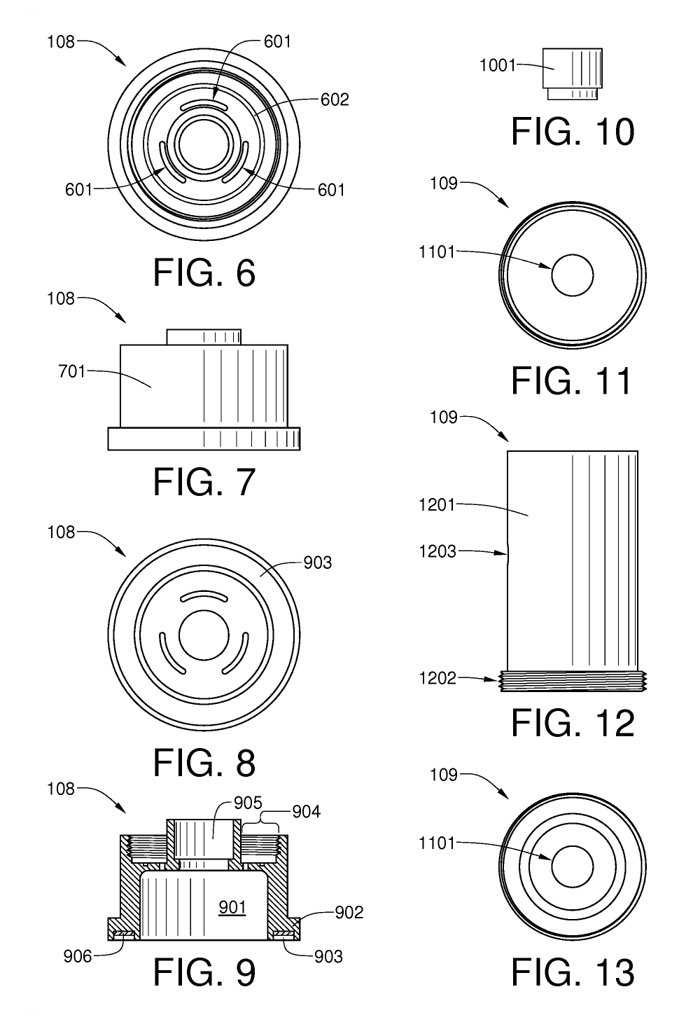

Referring now to FIGS. 6 through 9, a first embodiment lid 108 has a generally cylindrical exterior surface 701, a blade assembly retraction chamber 901 open at the bottom thereof, a lower rim 902 having an annular groove 903 that engages an upper rim of a mixing or cleaning cup, an upper annular recess 904 that is internally threaded to engage a first embodiment cleaning unit housing 109, the upper annular recess 904 surrounding a tubular vertical projection 905, in which a mixing shaft alignment bushing is installable. Three arcuate slots 601 provide fluid communication between the upper annular recess 904 and the blade assembly retraction chamber 901. The bottom of annular recess 904 is equipped with an O-ring groove 602. It will be noted that there is a silicone rubber seal 906 in an upper portion of the annular groove 903, which prevents the leakage of any fluid between the cup 117 and the lid 108.

Referring now to FIG. 10, a mixing shaft alignment bushing 1001, which installs within the tubular vertical projection 905, is shown. The alignment bushing 1001 can be made of high-density polyethylene (HDPE), polytetrafluoroethylene (PTFE), or other comparable material.

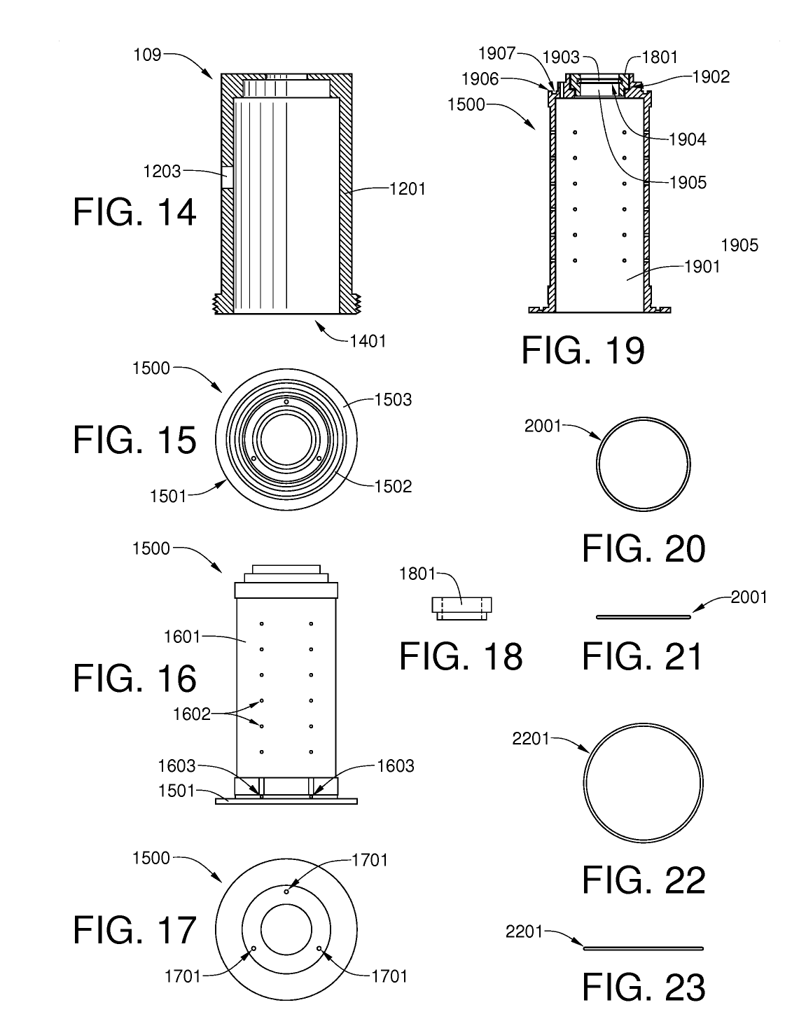

Referring now to FIGS. 11 through 14, a first embodiment cleaning unit housing 109 has a generally cylindrical body 1201 that has an unrestricted opening 1401 at a lower end thereof. The cylindrical body 1201 is partially closed at an upper end thereof, having an aperture 1101 sized to fit over the non-rotating mixer sleeve 106. The cylindrical body 1201 has an annular rim 1202 that is externally threaded to engage the internal threads of the lid 108. The cylindrical body 1201 also has a fluid entrance aperture 1203.

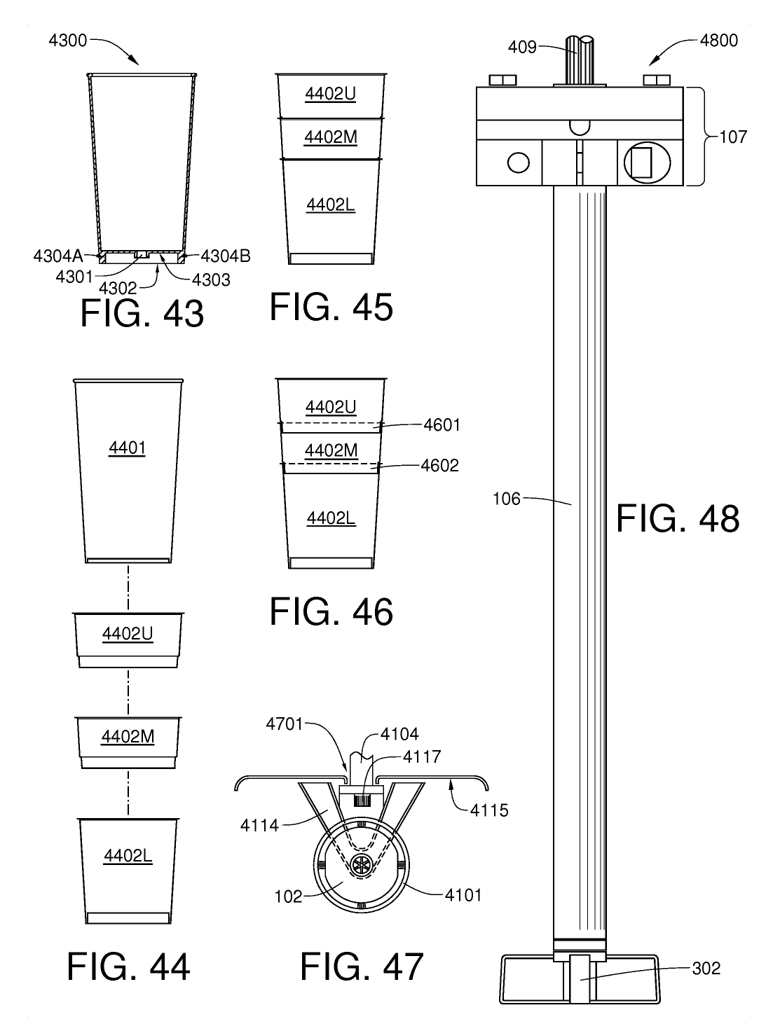

Referring now to FIGS. 15 through 19, a spray insert 1500, preferably made from a monolithic piece of polymeric material, is shaped much like a flanged spool with the upper flange removed. The lower flange 1501 has a first O-ring groove 1502 on an upper surface 1503 to receive an O-ring seal. A generally cylindrical body 1601 above the flange has multiple perforations 1602 that extend from an outer surface of the generally cylindrical body 1601 to an inner chamber 1901 which will surround the lower portion 301 of the non-rotating mixing sleeve 106, so that sanitizing fluid mixed with water will be radially sprayed toward the latter. The sprayed mixture then passes through the arcuate slots 601 in the lid 108, onto the blade assembly 302 and into a mounted cleaning cup (shown in FIG. 43). The spray insert 1500 fits within the first embodiment cleaning unit housing 109, and a plurality of drain apertures 1603 enable the space between the spray insert 1500 and the cleaning unit housing 109 to completely drain after a cleaning operation is performed. A plurality of apertures 1701 at the top of the spray insert provide a path for incoming air necessary for aeration of mixed drinks. A gap between the non-rotating mixing sleeve 106 and the aperture 1101 at the top of the first embodiment cleaning unit housing 109 completes the pathway to the exterior. FIG. 18 shows a bushing 1801 made of HDPE that has an inner O-ring seal (visible in FIG. 19) made of PTFE. In the cross-sectional view of FIG. 19 the bushing 1801 is shown inserted within a recess 1902 at the top of the spray insert 1500. The inner O-ring seal 1903, which fits within a circumferential groove 1904 within a central aperture 1905 of the busing 1801, rubs against the non-rotating mixing sleeve 106 when the latter is installed through the central aperture 1905. It will also be noted that the spray insert 1500 has an annular ledge 1906 that is equipped with a second O-ring groove 1907.

Referring now to FIGS. 20 and 21, an O-ring 2001 that fits within the second O-ring groove 1907 of the spray insert 1500 is shown.

Referring now to FIGS. 22 and 23, an O-ring 2201 that fits within the first O-ring groove 1502 of the spray insert 1500 and in the O-ring groove 602 at the bottom of annular recess 904 of the lid 108 is shown. It, of course, understood that two such O-rings 2201 are required for assembly of the cleaning unit.

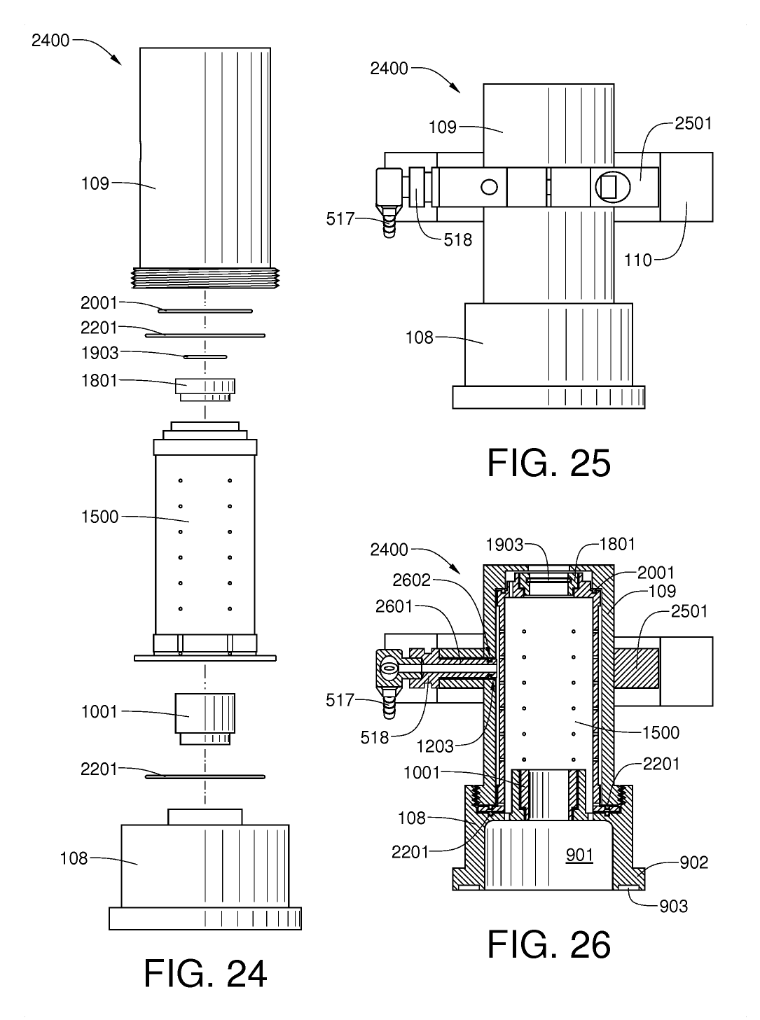

Referring now to FIG. 24, the first embodiment lid and cleaning unit assembly 2400 is shown in an exploded view. From top to bottom of this exploded view, the individual items are as follows: the first embodiment cleaning unit housing 109; O-ring 2001; O-ring 2201; the PTFE O-ring 1903; the bushing 1801; the spray insert 1500; the alignment bushing 1001; another O-ring 2201; and the lid 108.

Referring now to FIG. 25, the first embodiment lid and cleaning unit assembly 2400, consisting of the components shown in the exploded view of FIG. 24, has been completely assembled and clamped in a first embodiment lower trolley bracket 2501. The barbed coupling 517 is visible in this view, as is the fluid injector assembly 518.

Referring now to FIG. 26, in this cross-sectional view of the first embodiment lid and cleaning unit assembly 2400, it can be seen how the various components fit together. It will be noted that the fluid injector assembly 518 has a tubular projection 2601 that extends through the left side of the first embodiment lower trolley bracket and installs within the fluid entrance aperture 1203 in the generally cylindrical body 1201 of the first embodiment cleaning unit housing 109. An O-ring 2602 seals the connection.

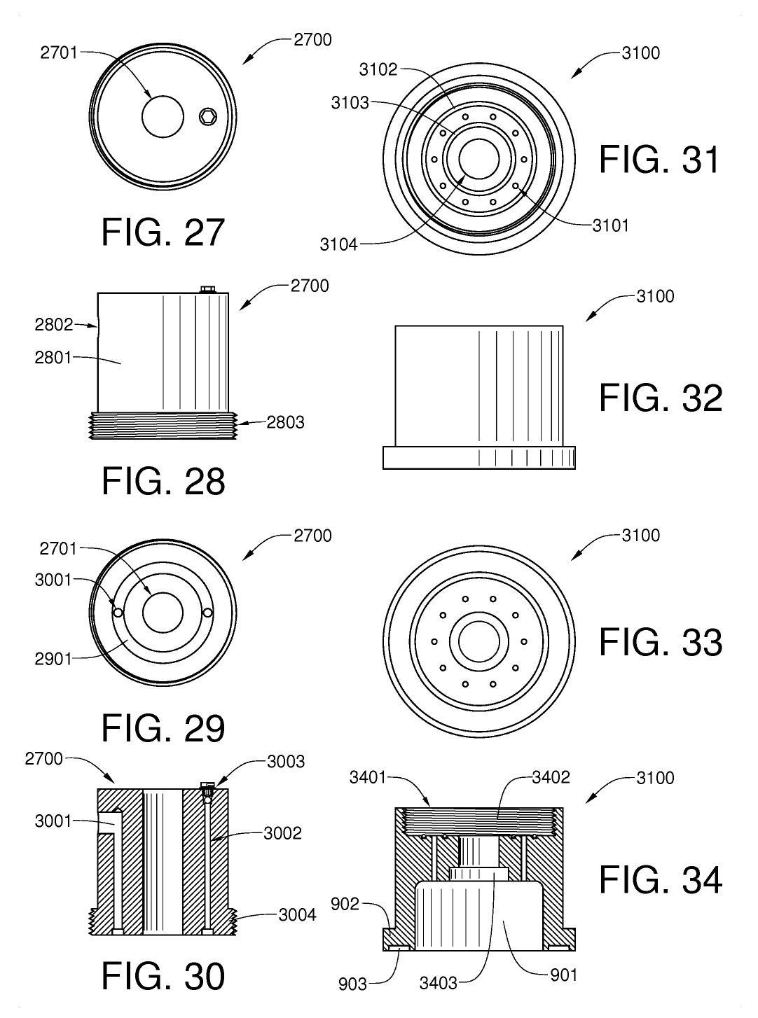

Referring now to FIGS. 27 through 30, a second embodiment cleaning unit housing 2700 has a generally cylindrical body 2801 that requires no spray insert, but rather directs the sanitizing fluid mixed with water directly to a second embodiment lid (see FIGS. 31 through 34) through an L-shaped first port 3001 which communicates with a fluid entrance aperture 2802 in the side of the generally cylindrical body 2801. An annular groove 2901 at the base of the generally cylindrical body 2801 distributes the sanitizing fluid and water around the lower portion 301 of the non-rotating mixing sleeve 106 which will pass through a cylindrical central aperture 2701, which extends from the top to the bottom of the generally cylindrical body 2801. A second port 3002 provides an air intake to the annular groove 2901 so that drinks being mixed will receive adequate air for aeration. A ball valve 3003 at the top of the second port 3002 prevents the escape of incoming pressurized sanitizing fluid and water. The cylindrical body 2801 has an annular rim 3004 with external threads 2803 that engage the internal threads of the second embodiment lid (shown in FIGS. 31 to 34).

Referring now to FIGS. 31 through 34, a second embodiment lid 3100 has a circular array of apertures 3101 that act as nozzles to clean the lower portion 301 of the non-rotating sleeve 106 and blade assembly 302. Each of the apertures 3101 in the circular array is in communication with the annular groove 2901 of the second embodiment cleaning unit housing 2700. Sealing of the annular groove is accomplished with a pair of O-rings (not shown in this view), each of which is installed within one of two O-ring grooves 3102 and 3103 at the bottom of a cylindrical recess 3401 in the top of the lid 3100. It will be noted that O-ring groove 3102 is larger in diameter than O-ring groove 3103. The cylindrical recess 3401 has internal threads 3402 which engage the external threads 2803 of the second embodiment cleaning unit housing 2700. Like the first embodiment lid 108, the second embodiment lid 3100 has a blade assembly retraction chamber 901 open at the bottom thereof, and a lower rim 902 with an annular groove 903 that engages an upper rim of a mixing or cleaning cup. A cylindrical aperture 3104, which fits over the non-rotating mixing sleeve 106, extends from the cylindrical recess 3401 to the blade assembly retraction chamber 901. It will also be noted that there is a recess 3403 at the lower end of the cylindrical aperture 3104, that will receive an annular wiping seal (not shown in this view).

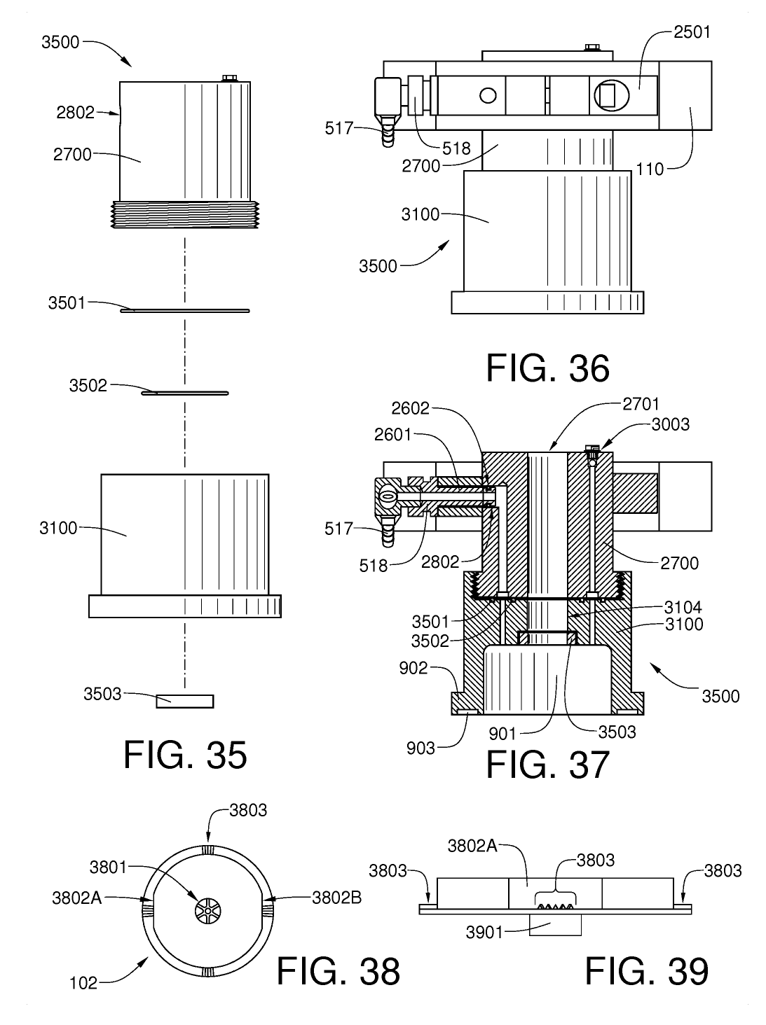

Referring now to FIG. 35, the second embodiment lid and cleaning unit assembly 3500 is shown in an exploded view. From top to bottom of this exploded view, the individual items are as follows: the second embodiment cleaning unit housing 2700; an O-ring 3501, which fits within the larger diameter O-ring groove 3102 of the second embodiment lid 3100; an O-ring 3502, which fits within the smaller diameter O-ring groove 3103 of the second embodiment lid 3100; the second embodiment lid 3100; and a wiping seal 3503 that fits into the recess 3403. The wiping seal 3503 prevents liquid from entering the gap between the lower portion 301 of the non-rotating sleeve 106 and the cylindrical aperture 3104.

Referring now to FIG. 36, the second embodiment lid and cleaning unit assembly 3500, consisting of the components shown in the exploded view of FIG. 35, has been completely assembled and clamped in a first embodiment lower trolley bracket 2501. The barbed coupling 517 is visible in this view, as is the fluid injector assembly 518.

Referring now to FIG. 37, in this cross-sectional view of the second embodiment lid and cleaning unit assembly 3500, it can be seen how the various components fit together. As with the first embodiment lid and cleaning unit assembly 2400, it will be noted that the fluid injector assembly 518 has a tubular projection 2601 that extends through the left side of the first embodiment lower trolley bracket 2501 and installs within the fluid entrance aperture 2802 in the generally cylindrical body 2701 of the second embodiment cleaning unit housing 2700. An O-ring 2602 seals the connection. It can also be seen how each of the apertures 3101 in the circular array is centered within the annular groove 2901.

Referring now to FIG. 38, a top view of the cup support 102 is shown. It will be noted that the cup support 102 is equipped with a central drain 3801, a pair of flattened parallel sides 3802A and 3802B, and four groups of five upward-facing sharpened projections 3803 around the perimeter that lock into the bottom edge of paper cups to prevent them from rotating during mixing operations. The base of a metal or plastic mixing cup may be shaped to engage the flattened parallel sides 3802A and 3802B to prevent the cup from rotating during mixing operations.

Referring now to FIG. 39, this enlarged side view of the cup support 102 of FIG. 38 clearly shows the shape of the upward-facing sharpened projections 3803. A drain connector 3901 is also visible in this view.

Referring now to FIG. 40, a modified first embodiment frozen drink mixer 4000 is shown that has been optimized for use with the second embodiment lid and cleaning unit assembly 3500. It will be noted that because the second embodiment lid and cleaning unit assembly 3500 is shorter than the first embodiment lid and cleaning unit assembly 2400, central portions of the frame 101, the mixer shaft assembly, including the non-rotating sleeve 106, the transmission output shaft 409 (which, as will be subsequently seen) extends into the mixer shaft assembly, the cylindrical vertical track rods 104A and 104B, the coupling rods 112A and 112B, and the jackscrew 401 can be shortened. A “-S” designation is given to these modified components to indicate that they have been shortened. No other structural changes to the mixer are deemed to be required.

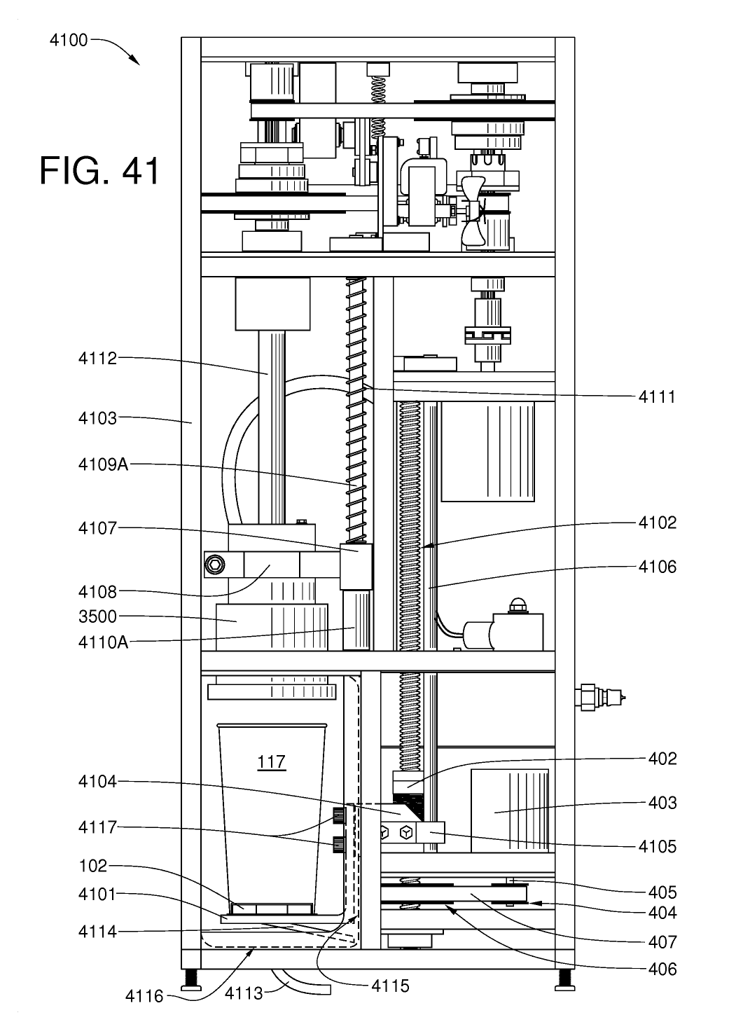

Referring now to FIG. 41, a second main embodiment frozen drink mixer 4100 is shown. The primary difference between this embodiment and the first embodiment frozen drink mixer 100 is that the blade assembly 302 remains at a constant elevation, and the cup support 102 is mounted on a movable platform 4101, which elevates a cup 117 mounted on the cup support 102. For the second main embodiment mixer 4100, a jack screw 4102 is installed behind the movable platform 4101 and secured to the frame 4103 at both ends so that it can rotate about its central axis. The jack screw 4102 is driven in an identical manner as before, with a reversible electric drive motor 403 coupled to the jack screw 4102 by a first toothed wheel 404 mounted on the motor output shaft 405, a second toothed wheel 406 mounted on the jack screw 4102, and a toothed belt 407, which rotationally couples the first and second toothed wheels 404 and 406, respectively. As the jack screw 4102 rotates, a jack screw follower 402, which engages the threads of the jack screw 4102, either rises or falls as the drive motor 403 operates, the direction of movement of the jack screw follower 402 being dependent on the direction of rotation of the drive motor 403. The movable platform 4101 is attached to the jack screw follower 402 by means of a follower attachment bracket 4104. A sliding guide 4105, which is bolted to the follower attachment bracket 4104, rides on a single, vertically disposed guide rod 4106 which is secured at both ends to the frame 4103. The sliding guide 4105 and the guide rod 4106 cooperate to maintain proper alignment of the movable platform 4101. Although this second main embodiment frozen drink mixer 4100 employs a second embodiment lid and cleaning unit assembly 3500, a first embodiment lid and cleaning unit assembly 2400 could also be employed. The only modifications required would be the resizing of various components to accommodate the additional vertical height of the first embodiment assembly 2400. The second embodiment lid and cleaning unit assembly 3500 is attached to a trolley 4107 via a modified trolley attachment bracket 4108. The trolley 4107 rides on a track 4109 which includes a pair of parallel vertical bars 4109A and 4109B (in this view, bar 4109B is hidden by bar 4109A). A pair of cylindrical stops 4110A and 4110B (only 4110A is visible in this view), which are coaxial with the parallel vertical bars 4109A and 4109B, respectively, limit downward travel of the trolley 4107. A return spring 4111 is installed over each vertical bar 4109A and 4109B and provides downward return biasing for the trolley and attached lid and cleaning unit assembly 3500.

Still referring to FIG. 41, when the cup 117 engages the annular groove 903 within the lower rim 902 of the second embodiment lid 3100, the cup begins to lift the lid 3100, thereby exposing the blade assembly 302 and non-rotating mixing sleeve 4112. As with the previously disclosed and described embodiments of the frozen drink mixer, this particular embodiment also has a cup support 102 with a central drain 3801. However, instead of being directly connected to the bottom drain tube 4113, the central drain 3801 of the cup support 102 empties into a drain chute 4114, which directs the waste water against the back wall 4115 of the mixer 4100, whence it flows into a catch basin 4116 below the movable platform 4101 and flows into the bottom drain tube 4113. It will be noted that knurled thumb screws 4117 enable the movable platform 4101 to be easily removed from the follower attachment bracket 4104 for cleaning.

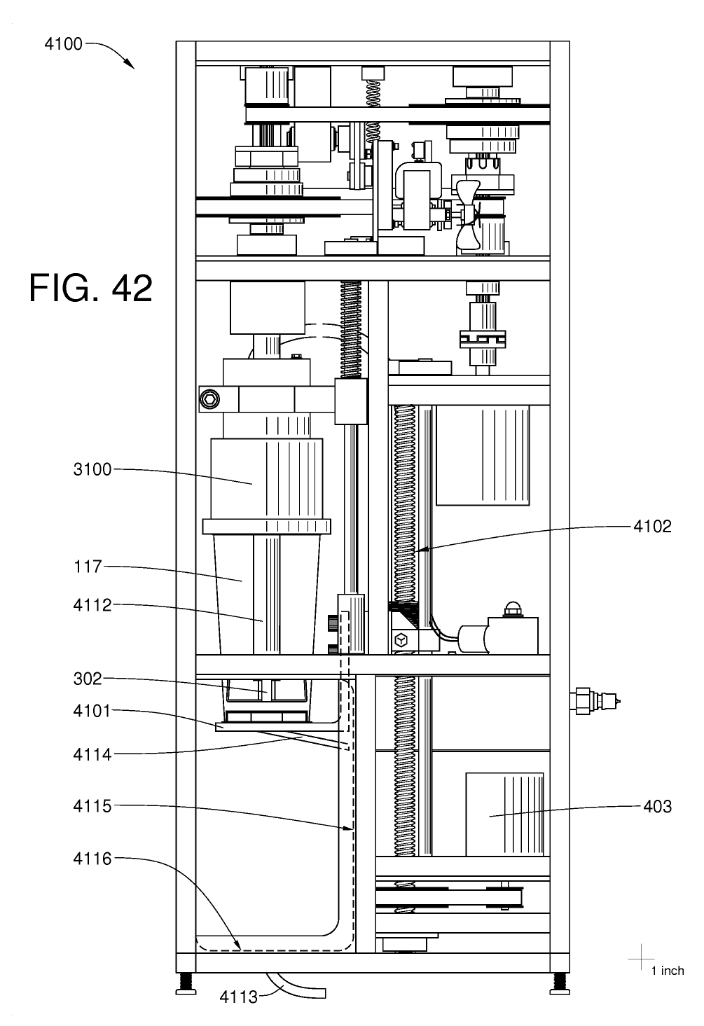

Referring now to FIG. 42, the second main embodiment frozen drink mixer 4100 is shown with the movable platform 4101 in an elevated position, whither it was moved by the combined action of the screw jack 4102 and the reversible drive motor 403. Raising of the movable platform 4101 and mounted cup 117 has, indeed, caused the cup 117 to lift the lid 3100, thereby exposing the blade assembly 302 and non-rotating mixing sleeve 4112.

Referring now to FIG. 43, this cross-sectional view of a cleaning cup 4300 shows the central drain 4301 in the bottom thereof. The base 4302 of the cleaning cup 4300 has a lower cylindrical recess 4303 with flattened parallel sides 4304A and 4304B, which engages the cup support 102 and prevents the cleaning cup 4300 from rotating on the cup support 102. The central drain 4301 of the cleaning cup 4300 fits into the central drain 3801 of the cup support 102.

Referring now to FIG. 44, this exploded view shows a 32-ounce paper cup 4401 positioned above a support sleeve 4402 having lower, middle and upper component sleeves 4402L, 4402M and 4402U, respectively. The lower component sleeve 4402L can be used alone with a 16-ounce paper cup to prevent the cup from collapsing as it lifts the lid and cleaning unit assembly of the second main embodiment frozen drink mixer 4100. The lower and middle components sleeves 4402L and 4402M, respectively can be used together to support a 24-ounce paper cup when used with the same embodiment drink mixer 4100. All three component sleeves 4402L, 4402M and 4402U can be used together to support a 32-ounce paper cup.

Referring now to FIG. 45, the three component sleeves 4402L, 4402M and 4402U have been assembled in order to receive a 32-ounce paper cup. The upper component sleeve 4402U can be removed to accommodate a 24-ounce paper cup, and the upper and middle component sleeves 4402U and 4402M can be removed to fit a 16-ounce paper cup.

Referring now to FIG. 46, this profile view of the three assembled component sleeves 4402L, 4402M and 4402U shows how the individual components fit together, with an overlapping region 4601 and 4602 for each connection.

Referring now to FIG. 47, the cup support 102, movable platform 4101, drain chute 4114, back wall 4115, and follower attachment bracket 4104 of the second main embodiment frozen drink mixer shown in FIGS. 41 and 42 are shown in this top view. It will be noted that the movable platform 4101 can be easily removed from the follower attachment bracket 4104 by unscrewing the knurled thumb screws 4117. It will be noted that the back wall 4115 has a vertical groove 4701 therein to accommodate movement of the follower attachment bracket 4104.

Referring now to FIG. 48, a first embodiment mixing shaft assembly 4800 is shown clamped within an upper trolley attachment bracket 107. The externally-splined output shaft 409 is visible, as are the non-rotating mixer sleeve 106 and the blade assembly 302.

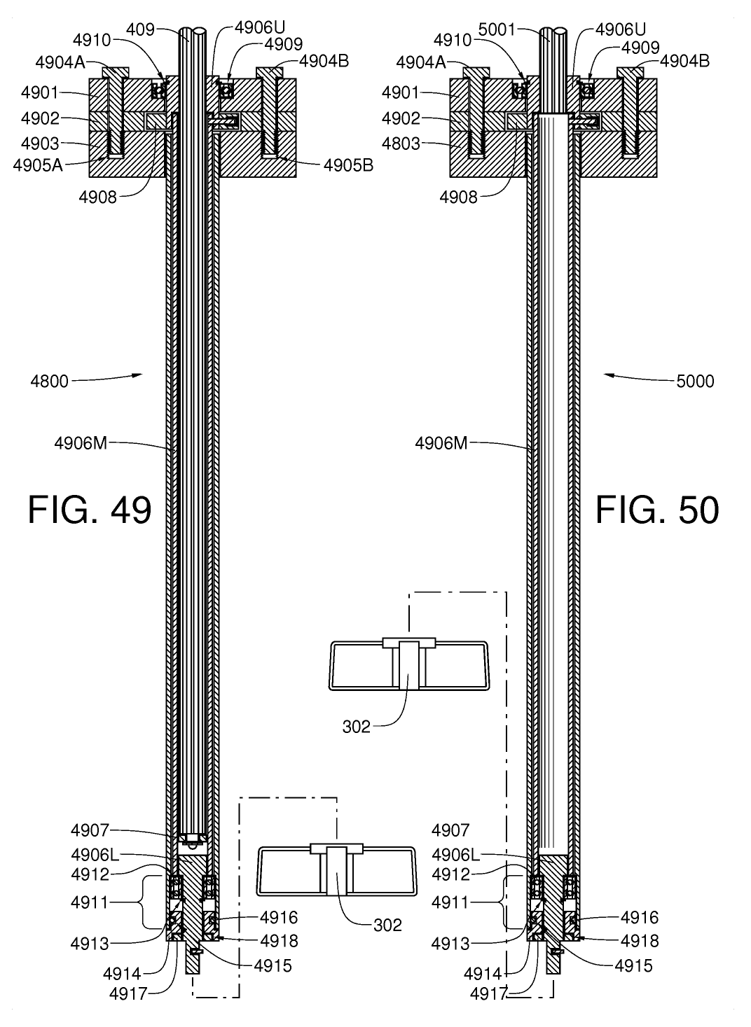

Referring now to FIG. 49, which is a partial cross-sectional view of the first embodiment mixing shaft assembly 4800, it will be noted that the upper trolley attachment bracket 107 comprises an upper plate 4901, a middle plate 4902, and a lower plate 4903. The upper plate 4901, the middle plate 4902, and the lower plate 4903 are secured together with a pair of threaded bolts 4904A and 4904B, which engage threaded holes 4905A and 4905B in the lower plate 4903. It will be further noted that the externally-splined output shaft 409, which is not cross-sectioned, extends downwardly within the mixing shaft assembly 4800 through a major portion of the latter's length. A rotating mixer shaft 4906 comprises a generally-solid, lower shaft portion 4906L, a tubular middle shaft portion 4906M, the lower end of which is rigidly secured to an upper end of the lower shaft portion 4906L, and an internally-splined upper portion 4906U which is secured to an upper end of the tubular middle shaft portion 4906M. The internally-splined upper portion 4906U engages the external splines of the output shaft 409 so that the rotating mixer shaft 4906 and the output shaft 409 are rotationally intercoupled. An annular bushing 4907 made of HDPE or PTFE is secured to the bottom end of the output shaft 409, thereby enabling the output shaft to slide within the tubular middle shaft portion 4906M without any metal-to-metal contact. A metal collar 4908 is pressed onto the bottom end of the internally-splined upper portion 4906 and screwed or pinned to the tubular middle shaft portion 4906M, thereby ensuring that the middle shaft portion 4906M will rotate with the internally-spined upper portion 4906. An upper ball bearing assembly 4909 slides over the internally-splined upper portion 4906 with minimal clearance, and is followed by an upper locking ring 4910, which prevents the upper ball bearing assembly 4909 from sliding up the internally-splined upper portion 4906. A lower inner portion 4911 of the non-rotating mixer sleeve 106 has been machined to reduce its wall thickness. A double-row ball bearing assembly 4912 slides over the lower shaft portion 4906L and is locked in place with a lower locking ring 4913. A bushing 4914 made of a generally non-corrosive metal and fitted with an O-ring groove 4915 and O-ring seal 4916 is inserted into the lower end of the non-rotating mixer sleeve 106. A spring-loaded seal 4917, which is pressed into a recess 4918 in a lower end of the bushing 4914, prevents fluid from seeping between the clearance between the lower shaft portion 4906L and the bushing 4914.

Referring now to FIG. 50, the mixer shaft assembly 4800 of FIG. 48 has been adapted for use with the second embodiment frozen drink mixer of FIGS. 41 and 42. The output shaft 409 has been shortened and the annular bushing 4907 has been eliminated. The output shaft 409 no longer slides within the internally-splined upper portion 4906U. Instead, the lower end of the output shaft 409 permanently engages the internally-splined upper portion 4906U.

Both main embodiments of the frozen drink mixer 100 and 4100, respectively, are shown in naked form. It is fully intended that the frames will be covered with a housing, which incorporates a cup loading door that will close when the drinks are mixed or when a cleaning operation is being performed with a cleaning cup 4300. Alternatively, the frame and housing may be an integral structure. Cost and aesthetics will likely determine the most appropriate form. Likewise, the cup loading door will open when the mixing or cleaning operation is complete.

The first main embodiment frozen drink mixer 100 has a rather dramatic production output advantage over the second main embodiment 4100 because of significant differences in design. Because the lid 108 must move only about 2 inches (about 5 cm) against spring tension provided by the right and left return springs 429 and 519, respectively, the return springs 429 and 519 can have a much greater combined spring constant than the combined return springs 4111 of the second main embodiment drink mixer 4100. If the combined spring constant of both return springs 4111 was equal to the combined spring constant of return springs 429 and 519 of the first main embodiment, the force required to compress return springs 4111 near the upper limit of lid and cleaning unit assembly travel would be dramatically higher than the force required to stretch return springs 429 and 519 near the upper limit of lid and cleaning unit assembly travel. When frozen ice cream is first mixed, it tends to remain as a frozen, agglomerated mass until it begins to thaw, primarily as a result of the energy absorbed from the mixing process. Thus, the spinning blade can cause the agglomerated, still frozen, mass to lift a lid that is not firmly pressed against the rim 118 of the mixing cup 117. Because the design of the first main embodiment frozen drink mixer 100 more easily lends itself to the use of a greater lid sealing force that remains constant throughout down/up cycling of the blade assembly 302, the first main embodiment 100 is capable of mixing frozen drinks-including milkshakes made with ice cream-in ten seconds (plus time required for loading and unloading the cup). Production output of the second main embodiment 4100, though, is highly dependent on the type of drinks being mixed. Although the production of a smoothie made with ice and fruit juices may take ten seconds, it may take up to forty seconds to mix a milkshake made with frozen ice cream to prevent the lifting of the lid 3100.

For presently preferred first and second main embodiments of the invention, the mixing motor 410 is geared by the transmission 114 to produce a low output speed at the output shaft 409 of about 1176 rpm and a high output speed at the output shaft of about 14,280 rpm. The shift mechanism are actuated by low-speed and high-speed selector switches located on a front panel of the drink mixer 100 or 4100.

For the first main embodiment frozen drink mixer, the upper trolley 105 has a maximum vertical travel of about 9 inches (approximately 23 cm), and must be able to travel twice that distance (i.e., down 9 inches and, then, up 9 inches) in approximately 10 seconds. Vertical movement of the upper trolley 105 can be controlled with a micro controller, a programmable logic controller (pic), a programmable logic controller servo (pics), or some similar device, in combination with at least one proximity sensor. A first main embodiment frozen drink mixer 100 has been constructed using a jack screw 401 having a pitch of 10 threads per inch (about 3.937 threads/cm).

There are two modes of operation: The first is a product mixing mode that will allow a mixer operator to select the velocity of the output shaft 409 and the number of down/up cycles traveled by the upper trolley 105 during a single mixing operation. Selection of one, two, three or four cycles are switch selectable on the front panel.

Each operational sequence begins and ends with the upper trolley 105 and the blade assembly 302 in their uppermost, or home, positions. This means that the blade assembly is within the blade assembly retraction chamber 901. A machine function sequence for a mixing operation includes the following steps:
1. The start button is pressed by the mixer operator;
2. The drive motor 403 turns on, causing the upper trolley 105, the mixing shaft assembly 4800, attached blade assembly 302, and the lid 108 to start moving downward;
3. The lid 108 mates with the mixing cup 117;
4. The mixing motor 410 turns on once the lid 108 has mated with the cup 117 and the blade assembly 302 begins to exit the blade assembly retraction chamber 901;
5. The upper trolley 105 and mixing shaft assembly 4800 continue their downward movement until the blade assembly 302 is located near the bottom of the cup 117;
6. The drive motor 403 reverses direction and the upper trolley and mixing shaft assembly 4800 begin upward movement until the blade assembly 302 returns to the blade assembly retraction chamber 901;
7. With the lid 108 still mated to the mixing cup 117, the drive motor 403 pauses for about 1 second, thereby allowing the blade assembly 302 to spin clean;
8. The mixing motor 410 then turns off;
9. The drive motor 403 turns on again and the upper trolley 105 resumes its upward movement until it returns to the home position.

If multiple down/up cycles are selected, the same basic sequence is followed, with exception the mixing shaft assembly 4800 and attached blade assembly 302 move up and down multiple times between the bottom of the mixing cup 117 and the lid 108, with the lid 108 remaining in contact with the mixing cup 117 throughout the selected number of down/up cycles.

The first and second main embodiment frozen drink mixers 100 and 4100 may also include an automatic (Auto) mode. When the Auto mode is selected, the frozen drink mixer will always execute one complete down/up cycle with the output shaft 409 revolving at low speed. After the first down/up cycle, the transmission is automatically shifted to produce high speed at the output shaft 409 for the remainder of the selected additional cycles (e.g., 1, 2, 3 or 4 cycles). At the completion of the mixing sequence, the transmission is automatically shifted to the low speed setting.

The second mode of operation is the cleaning mode. The cleaning mode is functionally the same as a mixing mode with three, 10-second cycles, but with the use of a cleaning cup having a bottom drain and the dispensing of cleaning solution (a mixture of water and sanitizing fluid) into the cleaning cup. During a cleaning sequence, the solenoid-actuated valve 512 is activated, thereby opening the valve 512, and allowing the cleaning solution to enter the cleaning cup 4300. The solenoid-actuated valve 512 stays open for 20 seconds (2 cycles), then the solenoid is closed. The last 10-second cycle is a dry run, allowing the cleaning solution time to drain from the cleaning cup 4300. The drain 4301 within the cleaning cup 4300 is sized so that the cleaning solution enters the cup 4300 at a considerably faster rate than that with which it flows into the drain 4301, thereby ensuring that the cleaning cup 4300 is at least half-full with cleaning fluid during the second down/up cycle of the cleaning sequence.

Although only several embodiments of the present invention have been disclosed herein, it will be obvious to those having ordinary skill in the art that changes and modifications may be made thereto without departing from the scope and spirit of the invention as hereinafter may be claimed.

What is claimed is:

1. An apparatus for mixing consumable ingredients in a mixing cup having a circular rim, the apparatus comprising:
a frame;
a cleaning cup that can be substituted for the mixing cup, the cleaning cup being of similar size and shape, but having a bottom with an aperture;
a support coupled to said frame for precise, axial, non-rotational mounting and support of the mixing or cleaning cup, said support having a drain that couples to the aperture when the cleaning cup is mounted on said support;
a lid positioned above said support and coupled to said frame, said lid having an annular groove on a lower surface thereof;
a rotatably-mounted mixer shaft coupled to said frame, said mixer shaft being coaxial with both a mounted mixing cup and the annular groove, and passing through said lid;
a mixing motor coupled to said mixer shaft;
a blade assembly coupled to a lower end of said mixer shaft, said blade assembly alternately assuming either a retracted position where it is recessed within the lid or an extended position where it is nearer said support, but still within the confines of a mounted cup;
means for alternatively bringing said support and said lid towards one another so that the annular groove of said lid can engage the rim of a mounted cup, and also distancing said support and said lid from one another so that the rim of a mounted cup can disengage from the annular groove of said lid;
means for alternately establishing the retracted and extended positions; and
means for dispensing washing solution into the cleaning cup.

2. The apparatus of claim 1, wherein said means for alternately establishing the retracted and extended positions comprises:
a vertical track rigidly secured to said frame;
an upper trolley bidirectionally and vertically movable along said vertical track, said upper trolley coupled to said mixer shaft so that the latter moves at the same vertical speed and with the same range of movement as said upper trolley; and
a reversible positioning system for driving said upper trolley in up and down vertical directions.

3. The apparatus of claim 2, wherein said means for alternately bringing and distancing comprises a lower trolley bidirectionally and vertically movable along said vertical track, said lower trolley being rigidly affixed to said lid, with upward movement of said lower trolley being provided by mechanical coupling to said upper trolley, the latter having a range of vertical movement greater than the former.

4. The apparatus of claim 3, wherein said reversible positioning system comprises:
a jack screw rotatably mounted to said frame, said jack screw acting on said upper trolley; and
a drive motor coupled to said jack screw.

5. The apparatus of claim 1, wherein said mixing motor is coupled to said mixer shaft through a transmission shiftable between low-speed, high-torque and high-speed, low-torque settings.

6. The apparatus of claim 5, wherein said transmission comprises:
first and second parallel shafts, said first shaft being directly coupled to said mixing motor, said second shaft being directly coupled to said mixer shaft, each of said parallel shafts having large-diameter and small-diameter wheels;
a pair of drive loops, each of which couples the large-diameter wheel of one shaft to the small-diameter wheel on the other; and
means to alternately rotationally lock either coupled wheel pair to both parallel shafts such that only a single coupled wheel pair and drive loop is functional at any given time.

7. The apparatus of claim 1, wherein said means for alternately bringing and distancing and said means for alternately establishing the retracted and extended positions comprise:
a vertical track rigidly secured to said frame;
a trolley bidirectionally and vertically movable along said vertical track, said trolley directly coupled to said support and movable therewith;
a reversible positioning system coupled to said trolley for generating upward and downward vertical movements thereof; and
at least one spring for biasing said lid in a downward vertical direction;
wherein when said reversible positioning system is generating upward vertical movement, said trolley, said support and a mounted cup are simultaneously raised, so that the mounted cup departs an initial lowered position where it is spaced away from said lid, and approaches said lid, then makes contact with said lid, thereby enabling the rim of the mounted cup to engage the annular groove, and finally overcomes the biasing of said at least one spring, thereby causing said lid to rise from its initial lowered position and expose said mixer shaft and attached blade assembly; and
wherein when said reversible positioning system is generating downward vertical movement, said trolley, said support and the mounted cup are simultaneously lowered, thereby causing said lid to travel, supported by the cup, until it has returned to its initial lowered position and covered said mixer shaft and blade assembly, further downward movement of said trolley and said support causing the rim of said cup to disengage said lid and the cup to return to its initial lowered position.

8. The apparatus of claim 7, wherein said reversible positioning system comprises:
a jack screw rotatably mounted to said frame, said jack screw acting on said trolley; and
a drive motor coupled to said jack screw.

9. The apparatus of claim 7, wherein said mixing motor is coupled to said mixer shaft through a transmission shiftable between low-speed, high-torque and high-speed, low-torque settings.

10. The apparatus of claim 9, wherein said transmission comprises first and second parallel shafts, said first shaft being more closely coupled to said mixing motor, said second shaft being more closely coupled to said mixer shaft, each of said parallel shafts having large-diameter and small-diameter wheels, with the large-diameter wheel of one shaft being coupled to the small-diameter wheel on the other with a drive loop, and means to alternately rotationally lock either coupled pair to both parallel shafts such that only a single coupled wheel pair and drive loop is functional at any given time.

11. The apparatus of claim 1, which further comprises a hollow non-rotatable sleeve which encases said mixer shaft and slides through said lid.

12. The apparatus of claim 1, wherein said means for dispensing washing solution into the cleaning cup comprises:
a chamber superjacent said lid which surrounds said mixer shaft, said chamber having a connection to a pressurized water source, said chamber having at least one path through said lid within the confines of the annular groove;
a source of sanitizing solution coupled to said connection; and
a solenoid-controlled valve which admits pressurized water and sanitizing solution to said chamber through the connection

13. The apparatus of claim 1, wherein said means for dispensing washing solution into the cleaning cup comprises:
at least one aperture in a lower surface of said lid within the confines of the annular groove, said at least one aperture having a connection to a pressurized water source;
a source of sanitizing solution coupled to said connection;
a solenoid-controlled valve which discharges pressurized water and sanitizing solution through said connection to said at least one aperture; and
a wiping seal centered in said lid which seals a gap between said lid and said mixer shaft, said wiping seal preventing mixed ingredients and washing solution from escaping in an upward direction and thereby eliminating the growth of bacteria cultures within the apparatus that could contaminate the mixed ingredients.

14. An apparatus for mixing consumable ingredients in a mixing cup having a circular rim, the apparatus comprising:
a frame;
a vertical track rigidly secured to said frame;
an upper trolley bidirectionally and vertically movable along said vertical track;
a reversible positioning system for driving said upper trolley in vertical directions;
a lower trolley bidirectionally and vertically movable along said vertical track, upward movement of said lower trolley is provided by mechanical coupling to said upper trolley, with range of movement of upper trolley being greater than that of lower trolley;
a cleaning cup that can be substituted for the mixing cup, the cleaning cup being of similar size and shape, but having a bottom with an aperture;
a support coupled to said frame for precise axial mounting and support of the mixing or cleaning cup, said support having a drain that couples to the aperture when the cleaning cup is mounted on said support;
a lid rigidly affixed to said lower trolley, said lid positioned above said support and having an annular groove on a lower surface thereof, and movable from an elevated position above the upper circular rim to a mating position where the annular groove engages a cup's circular rim;
a mixer shaft rotatably affixed to said upper trolley so that said mixer shaft moves at the same vertical speed and with the same range of movement as said upper trolley, said mixer shaft being coaxial with both a mounted mixing cup and the annular groove, and passing through said lid;
a mixing motor coupled to said mixer shaft;
a blade assembly secured to a lower end of said mixer shaft, said blade assembly movable relative to said lid from a retracted position where said blade assembly is recessed within said lid to an extended position where said blade assembly is nearer said support, and within the confines of a mounted cup;
means for dispensing washing solution into the cleaning cup.

15. The apparatus of claim 14, wherein said reversible positioning system comprises:
a jack screw rotatably mounted to said frame, said jack screw acting on said upper trolley; and
a drive motor coupled to said jack screw.

16. The apparatus of claim 14, wherein said mixing motor is coupled to said mixer shaft through a transmission shiftable between low-speed, high-torque and high-speed, low-torque settings.

17. The apparatus of claim 16, wherein said transmission comprises first and second parallel shafts, said first shaft being more closely coupled to said mixing motor, said second shaft being more closely coupled to said mixer shaft, each of said parallel shafts having large-diameter and small-diameter wheels, with the large-diameter wheel of one shaft being coupled to the small-diameter wheel on the other with a drive loop, and means to alternately rotationally lock either coupled pair to both parallel shafts such that only a single coupled wheel pair and drive loop is functional at any given time.

18. The apparatus of claim 14, wherein said means for dispensing washing solution into the cleaning cup comprises:
a chamber superjacent said lid which surrounds said mixer shaft, said chamber having a connection to a pressurized water source, said chamber having at least one path through said lid within the confines of the annular groove;
a source of sanitizing solution coupled to said connection; and
a solenoid-controlled valve which admits pressurized water and sanitizing solution to said chamber through the connection.

19. The apparatus of claim 14, wherein said means for dispensing washing solution into the cleaning cup comprises:
at least one aperture in a lower surface of said lid within the confines of the annular groove, said at least one aperture having a connection to a pressurized water source;
a source of sanitizing solution coupled to said connection;
a solenoid-controlled valve which discharges pressurized water and sanitizing solution through said connection to said at least one aperture; and
a wiping seal centered in said lid which seals a gap between said lid and said mixer shaft, said wiping seal preventing mixed ingredients and washing solution from escaping in an upward direction and thereby eliminating the growth of bacteria cultures within the apparatus that could contaminate the mixed ingredients.

20. The apparatus of claim 14, wherein downward movement of said lower trolley is provided by gravity assisted by spring tension.
